(19) United States
(12) Patent Application Publication
(10) Pub. No.: US 2007/0257073 A1
(43) Pub. Date: Nov. 8, 2007

(54) Buckle-knife

(76) Inventors: Kotenikov V. Konstantin, Severodvinsk citi (RU); Nikolaev V. Aleksander, Zlatoust citi (RU)

Correspondence Address: HERRON LAW OFFICE, PO BOX 2678, KANSAS CITY, KS, 66110, US

(21) Appl. No.: 11/061,227

(22) Filed: Feb. 18, 2005

(30) Foreign Application Priority Data
Feb. 19, 2004 (RU) 2004104685

(51) Int. Cl. B26B 29/02

(52) U.S. Cl. 224/232

(57) ABSTRACT

The invention is a buckle-knife including a housing, a spring mechanism and inserts. The inserts include a pair of knives within the housing and positioned to face towards each other. The knives have blades bearing an aperture and a longitudinal groove adjacent a center section thereof, and protrusions extending from sides of the blades and configured to pass into the apertures in order to hold the blades in a locked position. Also, the invention includes a catch positioned adjacent a center of the housing,. The catch has a stopping plate that is configured to pass through the openings in the blades when the buckle-knife is in the locked position.

### RELATION TO PRIOR APPLICATIONS

This application claims priority under Russian Publication entitled 2004104685. This document is incorporated herein by reference as if set forth verbatim herein.

### SUMMARY OF THE INVENTION

The invention is a buckle, such as a belt buckle, having an inlaid or built-in knife. The buckle-knife will include a housing, and a spring mechanism. The invention will also include inserts in the form of a pair a pair of knives situated within the housing and positioned to face towards each other. The blades of the knives have an aperture and a longitudinal groove adjacent a center section thereof The blades also bear protrusions extending from sides of the blades and configured to pass into the apertures in order to hold the blades in a locked position.

Further, the buckle-knife includes a catch positioned adjacent a center of the housing. The catch has a stopping plate that is configured to pass through the openings in the blades when the buckle-knife is in the locked position.

The buckle-knife may also include a base, two sidewalls and a cover plate atop the sidewalls. Optionally, the invention may have a first opening generally centrally positioned on the base, and screw-type threading positioned on edges of the first opening. In the embodiment, the invention will have a second opening generally centrally positioned on the cover plate. Thus, the first and second openings are aligned to provide coaxial receipt of the catch when the buckle-knife is in the locked position.

In another optional embodiment, the catch is a disk positioned on a rear face of the stopping plate and adjacent the screw-type threading. In this embodiment, a first side of the stopping plate has a width generally equal to a diameter of the opening of the blades, and a second side bears a width that is not greater than width of longitudinal groove.

In an alternate embodiment of the buckle-knife, the spring mechanism includes two springs positioned such that a first end of the spring abuts grooves within the base, and a second end of the spring abuts protrusions on the blades.

### DESCRIPTION OF THE DRAWINGS

FIG. 1 is a top view of the buckle-knife

FIG. 2 is a side view of the buckle knife.

FIG. 3 shows the blades of the buckle-knife inside a buckle.

FIG. 4 shows a side view of the embodiment in FIG. 3

FIG. 5 shows a detail of the spring mechanism.

FIG. 6 is a bottom view of the buckle-knife.

FIG. 7 shows an isolated view of the catch.

FIG. 8 it is shown the catch (position 2)

### DETAILED DESCRIPTION OF THE PREFERRED EMBODIMENTS

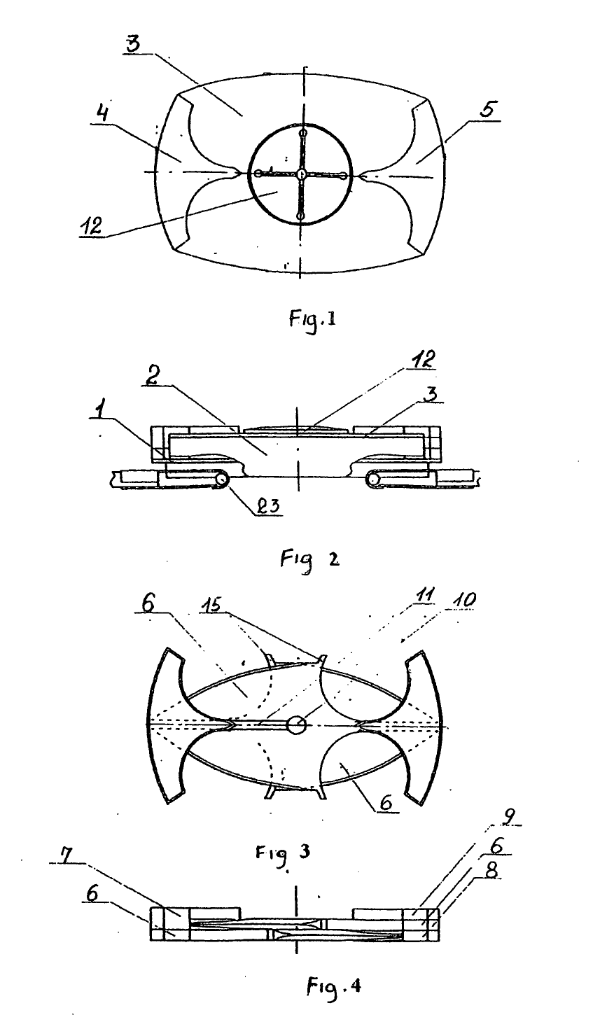

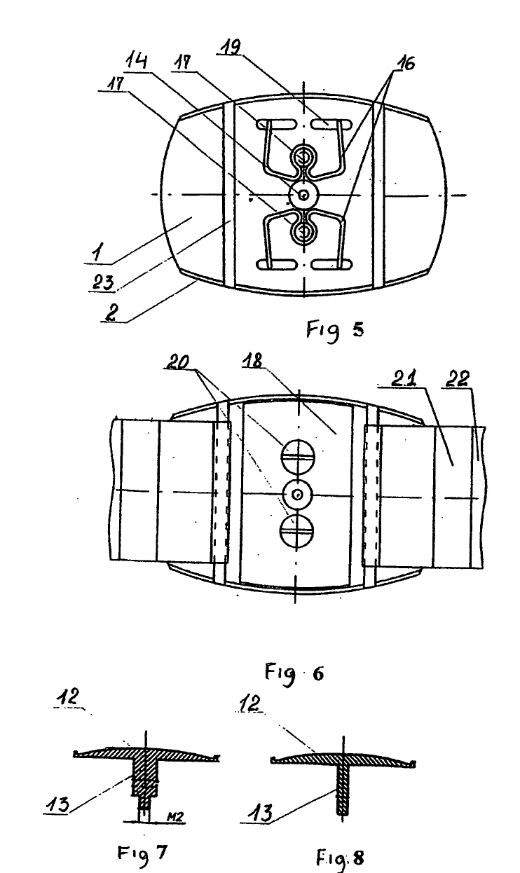

As seen in FIGS. 1 and 2, the invention includes base 1, sidewalls 2, and a cover plate atop the sidewalls 2 Knife 4 includes blade 6 and cover plate 7; knife 5 has blade 6 and two cover plates 8 and 9.

The moving parts of the buckle-knife are knife-blades that bear a tapered form. Preferably, the blades are double-edged. In the center, the blade has opening 10, and a longitudinal groove. The center cover plate 3 and base 1 have coaxially aligned openings for the insertion of catch 12, which bears the the form of the disk. The disk includes a stopping plate 13 having one side that is equal to the diameter opening 10, and another side that is less the width longitudinal groove 11. Threading stops and retains the plate. The diameter by which it is equal to the size of less the side stopping plate (FIG. 7,8).

To facilitate the opening of the buckle-knife, a cross or the like may be formed on the outer surface of the disk. The catch 12 is inserted into the opening cover plate 3 and it is screwed up into the threading located in central the opening base 1. The blade has semicircular cuts formed in a central part of the blad. The edges of the blades may form swallowish tail and formed by the body of the blades 6 and by the cover plates 7 and 8,9.

As shown in FIG. 5, a spring mechanism is positioned in a rear portion of the housing on base 1. It includes two springs 16, fixed on the basis by means of washers 17 and the holder. Bent back portions of the springs 16 are situated in grooves 19 formed in base 1. These springs fit within grooves 19 on one end, and abut against protrusions 15 blades 6 on the other. Bolts 20 attach holder 18 to the base 1.

To assemble the buckle-knife, knives 4 and 5 are placed into the housing and are compressed towards to each other. The knives 4,5 are held within the housing by the turning catch 12, and by inserting the catch into the opening 10 of the stopping plate 13. The larger side by the side across the groove 11.

As the catch is rotated, the stopping plate 13 is also turned and it arises (position 1), from the side along groove 11 and the blades are pushed outwardly from the housing by the spring mechanism

The inventive buckle-knife combines two useful and functional objects: it is a buckle for an article (such as a belt), and also is a discreet, undetectable, hidden, and disguised tool for self defense that is lightweight, small, compact, compact, and easy to carry.

Because the buckle-knife is relatively small and inconspicuous, it can be worn without being noticed; conversely, a defensive weapon that is noticeable often causes those around the carrier to feel uneasy, threatened, or alarmed. Further, because the buckle-knife will be commonly used as a belt-buckle, the buckle-knife will usually be easily accessible in the event of an emergency need for defense.

Although the present invention has been described and illustrated in detail, the herein above descriptions set forth are to be clearly understood that the same is by way of illustration and example only, and is not to be taken by way of limitation. The spirit and scope of the present invention are to be limited only by the terms of the appended claims.

We claim:

1. A buckle-knife, comprising:
a housing,
a spring mechanism;
inserts, including
a pair of knives within the housing and positioned to face towards each other, the knives having blades bearing an aperture and a longitudinal groove adjacent a center section thereof, and protrusions extending from sides of the blades and configured to pass into the apertures in order to hold the blades in a locked position; and,
a catch positioned adjacent a center of the housing, the catch having a stopping plate that is configured to pass through the apertures in the blades when the buckle-knife is in the locked position.

2. The buckle-knife as in claim 1, the housing including
a base, two sidewalls, and a cover plate atop the sidewalls;
a first opening generally centrally positioned on the base, and screw-type threading positioned on edges of the first opening;
a second opening generally centrally positioned on the cover plate; and wherein
the first and second openings are aligned to provide coaxial receipt of the catch when the buckle-knife is in the locked position.

3. The buckle-knife as in claim 1, wherein the catch is a disk positioned on a rear face of the stopping plate and adjacent the screw-type threading, wherein a first side of the stopping plate has a width generally equal to a diameter of the apertures of the blades and a second side bears a width that is not greater than width of longitudinal groove.

4. The buckle-knife as in claim 1, wherein the spring mechanism includes two springs positioned such that a first end of the spring abuts grooves within the base, and a second end of the spring abuts protrusions on the blades.

5-8. (canceled)
